(19) United States
(12) Patent Application Publication
(10) Pub. No.: US 2018/0230285 A1
(43) Pub. Date: Aug. 16, 2018

(54) METHOD FOR RECOVERING INORGANIC FIBRES AT ROOM TEMPERATURE IN COMPOSITE MATERIALS OF FIBRE AND RESIN

(71) Applicant: UNIVERSIDAD DE ALICANTE, San Vicente Del Raspeig (Alicante) (ES)

(72) Inventors: Agustín BUENO LOPEZ, San Vicente Del Raspeig (Alicante) (ES); Dolores LOZANO CASTELLÓ, San Vicente Del Raspeig (Alicante) (ES); Francisco PERUCHO SANCHEZ, Alicante (ES)

(21) Appl. No.: 15/750,475

(22) PCT Filed: Jul. 27, 2016
(86) PCT No.: PCT/ES2016/070570

§ 371 Date: Feb. 5, 2018

(30) Foreign Application Priority Data
Aug. 6, 2015 (ES) P201531174

(51) Int. Cl. C08J 11/02; C08J 11/18

(52) U.S. Cl. CPC C08J 11/02; C08J 11/18

(57) ABSTRACT

The invention relates to a method by which means inorganic fibres (glass, carbon, aramide, etc.) are recovered from composite materials of fibre and resin, with the significant advantage of working at room temperature. The method comprises the steps of treatment with solvent and separation of the fibre from the residues of degraded resin.

Method for recovering inorganic fibres at room temperature in composite materials of fibre and resin.

### FIELD OF THE INVENTION

The invention relates to a method by which means inorganic fibres (glass, carbon, aramide, etc. . . . ) are recovered from composite materials of fibre and resin.

### BACKGROUND ART

Cabin cruisers, yachts and different types of boats are made up of composite materials of fibre and resin for the hull and superstructure. These composite materials are mainly manufactured from polyester and fibreglass, a combination that makes them simultaneously light and strong. Composite materials of fibreglass and resin are also used to manufacture the blades of wind turbines that transform wind energy into electricity. Although fibreglass is the most commonly used inorganic fibre due to economic reasons, other types of fibre, such as aramide or carbon fibres, are sometimes used as well, either alone or as reinforcement for fibreglass.

The automotive and aviation industries also use composite materials of fibre and resin. For example, the structure of the Airbus A380 is made up of 40% carbon fibre, and in 2013 BMW marketed the first car manufactured in series with carbon fibre.

Countless other applications of the composite materials of fibre and resin that could be mentioned are the manufacture of sporting equipment, tanks, marine ladders, handrails, structural parts, insulation, etc. Most of the applications take advantage of the fact that the composite materials of fibre and resin are lightweight, have good mechanical properties, are resistant to corrosion and need little maintenance. In the case of fibreglass, they are also cheap.

In Europe, more than 120,000 tonnes of composite materials of fibreglass and resin are currently sent to landfills every year, and a large part of this amount comes from their use as a building material for boats. In the case of carbon fibres, for example, the global demand in 2008 increased to 35,000 tonnes, with an annual increase of 7-8%. This creates a significant problem, since final dump sites should be made available for these residues once their useful life has ended. The storage of these residues poses a problem for the environment and may even become damaging to one's health, which is mainly due to the degradation of polymer resin.

One alternative to the accumulation of residues in landfills is the recycling thereof to eliminate resin and recover the inorganic fibres (glass, carbon, aramide, etc.). The inorganic fibres could be reused, which would save a large amount of energy needed for the manufacture thereof and would give added value to the recycling process.

To date, several methods for recycling composite materials of fibre and resin have been developed. The publication “Recycling of Reinforced Plastics” (Appl Compos Mater (2014) 21:263-284) includes the methods available for recycling composite materials of fibreglass and resin, and the publication “Recycling carbon fibre reinforced polymers for structural applications: Technology review and market outlook” (Waste Management 31 (2011) 378-392) includes those available for materials of carbon fibre and resin. Said methods are summarised below.

There are methods based on mechanical treatments of the residue, such as, for example, grinding the composite material. This method can be applied to all composite materials, regardless of the nature of the fibre and the resin. It is currently the only option with commercial application. The major constraint of this method is the fact that the fibres lose their mechanical properties upon being ground. This limits the reuse thereof in low value-added applications in which said mechanical properties are not necessary; however, most of the original applications of the fibres are ruled out. The patents US20080217811 and WO2013076601 are examples of this type of treatment in which the ground composite material is mixed with new resin and is used to make insulation panels.

The multinational company Befesa has developed a recycling method that consists of incorporating the residues of the composite material of fibreglass and resin into a new polymer matrix by binding them chemically. Thus, the final product that is obtained, which is a mixture of already recycled fibreglass and plastic, can be reused in applications that do not require very specific mechanical properties.

There are also recycling methods based on the pyrolysis of the composite material of fibre and resin, wherein the resin is eliminated by means of thermal treatment in a non-oxidant atmosphere at a high temperature (450-650° C.). In the patent WO2005040057, a process of this type is disclosed, wherein it alludes to the fact that the polymer matrix which contains the fibre is eliminated by pyrolysis, gasification, incineration or combustion of the resin matrix. The major drawback of these methods is that they are contaminants and they partially degrade the fibres, which limits or makes it impossible to reuse them.

The methods based on hydrolysis consist of treating the composite material of fibre and resin with water by using an acid or base catalyst. These methods have the added problem that the fibre must be separated after the treatment and that the fibres also degrade, such that it also does not enable the reuse thereof in applications that require good mechanical properties.

Another option are the methods based on simply recovering energy, which consist of burning the resin (normally at temperatures close to 1000° C.) to use the energy emitted. However, these methods also have the drawback that the fibre is not recovered, and therefore, cannot be reused.

Given this problem, the company SINTEF, together with a group of Norwegian companies and organisations, have developed a method to make use of the materials used in boats through a chemical recycling process that enables the resin to be separated from the fibreglass so that both products can be reused (www.sciencedaily.com/releases/2011/06/110609083228.htm). The inventors suggest that the process is effective, since it enables approximately 80% of the materials that make up boats to be recycled. However, the industrial implementation thereof has the drawback that the materials must be treated at high temperatures, close to 220° C. for 2 hours, which makes the application thereof significantly more difficult.

Therefore, there is currently no method for recycling composite materials of fibre and resin that enables the recovered inorganic fibres to be reused and does not use aggressive treatments that degrade the fibres, whether they are mechanical or chemical at high temperatures.

### DESCRIPTION OF THE INVENTION

In light of the above, it is necessary to look for a comprehensive solution to the problem of recycling composite materials of fibre and resin by means of methods that can be carried out under mild temperature conditions and are not chemically aggressive with the inorganic fibres, such that they enable the reuse thereof.

The major advantage of the method described herein is that it enables the resin to be separated from the fibres at room temperature, recovering the fibres without being damaged and enabling the subsequent use thereof. To do so, a halogenated organic solvent must be used, preferably a chlorinated organic solvent, or any other halogenated solvent, to recover the inorganic fibre by chemically separating the fibre from the resin matrix.

Therefore, the present invention relates to a method by which means inorganic fibres are separated from the resin in composite materials of fibre and resin by means of chemical treatment at room temperature, which enables the inorganic fibre to be recovered without damaging it.

Thus, in a first aspect, the present invention relates to a method for recovering inorganic fibres from a composite material of fibre and resin (hereinafter, method of the present invention) which is carried out a room temperature and comprises the following steps:
a) treatment of the composite material of fibre and resin with a halogenated organic solvent,
b) separation of the fibre from the resin of the material dissolved in step a).

In the present invention, room temperature is understood as a temperature that does not exceed the boiling point of the solvent.

In a more particular embodiment, the method of the present invention comprises a step prior to step a) for conditioning and cutting the starting material of fibre and resin and eliminating other materials, such as wood, metal, etc.

In a particular embodiment of the present invention, the inorganic fibres are selected from among fibreglass, carbon fibres or aramide fibres.

In a particular embodiment, the resin of the composite of fibre and resin is a thermosetting resin or a hot-melt resin with enough reactivity to be degraded by the solvent used.

In a particular embodiment, the halogenated organic solvent is a chlorinated organic solvent. More specifically, the chlorinated organic solvent is selected from among dichloromethane, chloroform, 1,2-dichloroethane, trichloroethylene, chlorobenzene.

In a particular embodiment, step a) for treating the composite material of fibre and resin is carried out in a reactor.

In another particular embodiment, step a) for treating the composite material of fibre and resin is carried out by stirring.

In another particular embodiment, step a) for treating the composite material of fibre and resin is carried out for 15-180 minutes.

In another particular embodiment, the halogenated organic solvent is recovered by means of a solvent extraction system and the residual organic solvent is eliminated. More specifically, the residual organic solvent is eliminated by applying a stream of immiscible gas or liquid in the reactor or applying a temperature higher than the boiling temperature of the solvent.

In another particular embodiment of the present invention, step b) for separating the fibre from the resin of the material dissolved in step a) is carried out by means of sifting.

The method of the present invention is capable of being automated and scaled to be able to work at different scales. In other words, it can be scaled at any time to increase performance and attain a larger amount of recovered materials, or even modify the configuration while respecting the steps defined in the method.

All the materials used in the present invention which are described below (closure seals, conduits, reactors, etc.) should be compatible with the solvent used.

The basic steps of the method are described below.

### Prior Step of Conditioning the Composite Material of Fibre and Resin.

This optional prior step consists of conditioning the composite material of fibre and resin, eliminating other materials, such as, for example, wood, metal, etc. and cutting the composite material of fibre and resin into fragments of dimensions suitable for the dimensions of the facility.

Step a: Treatment of the Composite Material of Fibre and Resin with a Halogenated Organic Solvent.

The first step of the method consists of introducing the fragments of composite material of fibre and resin into a reactor and treating them with a halogenated organic solvent to degrade the resin. When the solvent comes in contact with the cut composite material, the resin degrades and the fibre begins to separate.

Although it is not required, it is recommended that the reactor have at least an agitation system for accelerating the degradation of the resin and the separation of the fibres.

After the degradation of the resin, the solvent is extracted from the reactor, taking it to the original tank thereof, using a particle filter so that the solvent comes out clean.

Once most of the solvent has been removed from the reactor, the solvent that is impregnated in the mixture of fibres and degraded resin is then eliminated. This can be done in several different ways or combinations thereof. One option is to introduce an immiscible liquid (for example, water) into the reactor which, after washing the mixture of fibres and degraded resin, is removed from the reactor. Both liquids are subsequently separated by decanting, recovering the solvent. The mixture of fibres and degraded resin must finally be dried, either in the reactor itself (helping it with temperature and the circulation of air, for example) or outside of it.

Another alternative for eliminating the halogenated organic solvent that impregnates the mixture of fibres and degraded resin is heating the reactor above the boiling temperature of the solvent (for example, 40° C. for dichloromethane, 61° C. for chloroform, 84° C. for 1,2-dichloroethane, etc.) and carrying the evaporated solvent with a gas (for example air). The carrier gas previously heated to the necessary temperature can also be introduced. To avoid solvent emissions, this can be subsequently recovered by condensation or by adsorption in an adsorbent solid (activated carbon, zeolites, silica gel, etc.). This alternative avoids the drying step, but it requires additional energy to reach a temperature higher than the boiling point of the solvent.

Lastly, the mixture of fibres and degraded resin of the main reactor are then dried (if it has not been done before), moving on to step b) of the process.

In a particular embodiment, it would desirable that all of step a) of the process is carried out in an airtight area, for example, inside a compartment with forced ventilation and a gas adsorption system, for example, an active carbon filter. For the correct functioning of the method, it is necessary to ensure that the temperature of the area wherein it is carried out is lower than the boiling point of the solvent. Therefore, in the case of using a solvent with a boiling point close to room temperature (for example, 40° C. for dichloromethane), an air-conditioning system may be necessary.

Step b: Separation of the Inorganic Fibres from the Residues of Degraded Resin.

This step can be carried out by means of sifting, such that the larger fibres are separated from the smaller degraded resin particles, subjecting them to a vibration system in a sieve that lets the degraded particles of resin pass through.

### BRIEF DESCRIPTION OF THE FIGURES

FIG. 1 shows a diagram of the experimental process that could be used to carry out the method for recovering the inorganic fibres. It shows a solvent tank 1, a reactor 2, a pump 3 for transferring the solvent, a conduit for extracting the solvent from the reactor 4 and a fluid inlet 5.

### DETAILED DESCRIPTION OF EMBODIMENTS

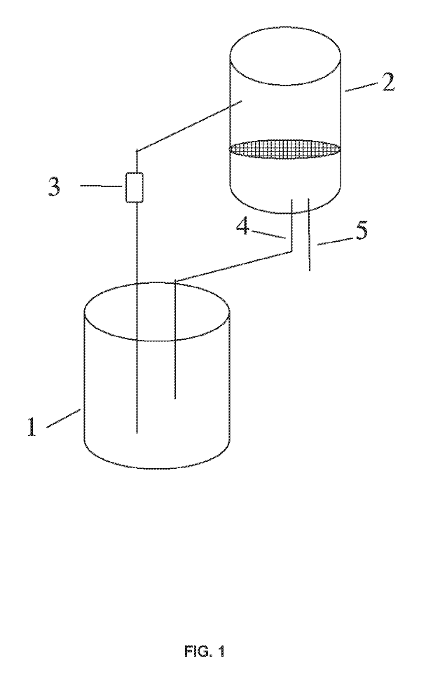

The preferred embodiment of the method described in the present invention is described below. For better comprehension thereof, FIG. 1 is shown.

To start the method, the solvent tank 1 is filled. This tank is used to store the halogenated organic solvent and has an airtight lid that prevents the solvent from evaporating to the outside.

The solvent should be a halogenated organic solvent, selected from among dichloromethane, chloroform, chlorobenzene or other solvents with similar characteristics. The choice of one solvent or another can be based on mainly economic criteria.

The inorganic fibres are made from glass, carbon or aramide. Among these three, the fibre type does not affect the method.

The nature of resin is important, being able to be used with most resins, except for some with a hot-melt nature that, due to the chemical inertness thereof, are degraded by the halogenated organic solvents.

### Prior Step: Conditioning the Composite Material of Fibre and Resin.

This prior step is optional and during this step, the composite material of fibre and resin is separated from other materials that can be present, such as wood or metal, and cut into fragments according to the dimensions of the reactor 2. The reactor 2 is the vessel wherein the composite material of fibre and resin is treated with the solvent to recover the inorganic fibres. It has a cover that seals hermetically and can be opened or closed to introduce the starting composite material of fibre and resin and remove the recovered fibre following the method. Once the material is cut, it is placed in the reactor 2 to continue with the following steps of the method.

The fragments will have a larger or smaller size according to the dimensions of the reactor used in step a). Although it is not essential, by way of indication, the fragments can have a size of approximately one-tenth of the diameter of the reactor.

Step a: Treatment of the Composite Material of Fibre and Resin with a Solvent.

Next, the solvent is pumped from the solvent tank 1 to the reactor 2 where the composite material of fibre and resin is cut. To do so, the pump 3 is used.

When the halogenated organic solvent (in this case a chlorinated organic solvent is used, specifically 1,2-dichloroethane) comes in contact with the cut material of fibre and resin, the resin and fibre begin to separate. It is recommended to use an agitation system to keep the content of the reactor moving during the treatment. Once the fibres and resin are separated, the agitation system is stopped, if there is one.

This chemical treatment should be stopped as soon as the resin begins to degrade, without waiting for the resin to dissolve completely. In doing so, the recovered solvent can be subsequently reused in successive steps. The time required usually varies between 15 and 180 minutes, and the optimisation thereof depends on the type of resin treated, the solvent used and the design of the reactor.

Next, the solvent is extracted from the reactor 2 through the conduit 4, taking it to the solvent tank 1 once again. This extraction can be carried out by gravity, and the conduit 4 should be protected with a particle filter to prevent the degraded resin particles, together with the solvent, from exiting the reactor 2.

Next, the solvent is eliminated from the fibres by heating the reactor 2 above the boiling point of the solvent (for example, 40° C. for dichloromethane, 61° C. for chloroform, 84° C. for 1,2-dichloroethane, etc.), and air is introduced through the air inlet 5 to carry the evaporated solvent. The solvent eliminated in the drying step can be retained in the filter (for example, of activated carbon, zeolite, silica gel, etc.) before expelling the air current to the outside, or it can be condensed to be reused. As already indicated in the general description, instead of air, water, or another liquid immiscible with the halogenated organic solvent, can also be introduced into the reactor, subsequently separating the solvent and said liquid by decanting. In this case, it would be necessary to subsequently dry the fibres.

Step b: Separation of the Fibres from the Residues of Degraded Resin.

Lastly, the fibres are extracted from the reactor 2, which are mixed with a large amount of degraded resin particles. The mixture of fibres and resin particles can be separated by means of sifting, subjecting them to vibration in a sieve of a sufficient size so that the fibres do not pass through it, but the particles do. A fluidisation system or any other system suitable for separating solids can also be used.

The obtained fibres have physical and chemical properties similar to the original fibres, only partially losing the structural order in the case of treating fibres with a specific arrangement.

This makes it possible for them to be reused in any application in which perfectly arranged fibres are not necessary.

1. A method for recovering inorganic fibres from a composite material of fibre and resin, characterised in that it is carried out at room temperature and comprises the following steps:
a) treatment of the composite material of fibre and resin with a halogenated organic solvent
b) separation of the fibre from the resin of the material dissolved in step a).

2. The method according to claim 1, which comprises a step prior to step a) for conditioning and cutting the starting material of fibre and resin.

3. The method according to claim 1, wherein the inorganic fibres are selected from among fibreglass, carbon fibres or aramide fibres.

4. The method according to claim 1, wherein the halogenated organic solvent is a chlorinated organic solvent.

5. The method according to claim 4, wherein the chlorinated organic solvent is selected from among dichloromethane, chloroform, 1,2-dichloroethane, trichloroethylene, chlorobenzene.

6. The method according to claim 1, wherein step a) for treating the composite material of fibre and resin is carried out in a reactor.

7. The method according to claim 1, wherein step a) for treating the composite material of fibre and resin is carried out by stirring.

8. The method according to claim 1, wherein step a) for treating the composite material of fibre and resin is carried out for 15-180 minutes.

9. The method according to claim 1, wherein the halogenated organic solvent is recovered by means of a solvent extraction system and the residual organic solvent is eliminated.

10. The method according to claim 9, wherein the residual organic solvent is eliminated by applying a stream of immiscible gas or liquid in the reactor.

11. The method according to claim 9, wherein the residual organic solvent is eliminated by applying a temperature higher than the boiling temperature of the solvent.

12. The method according to claim 1, wherein step b) for separating the fibre from the resin of the material dissolved in step a) is carried out by means of sifting.
